(19) United States
(12) Patent Application Publication
(10) Pub. No.: US 2024/0419742 A1
(43) Pub. Date: Dec. 19, 2024

(54) SYSTEMS AND METHODS FOR AUTOMATED DOCUMENT INGESTION

(71) Applicant: Innovative Logistics, LLC, Fort Smith, AR (US)

(72) Inventors: Andrew Karl Marcum, Greenwood, AR (US); Earideth Eugene Anderson, Greenwood, AR (US); Charles Bradford Astor, Fort Smith, AR (US)

(21) Appl. No.: 18/743,793

(22) Filed: Jun. 14, 2024

Related U.S. Application Data
(60) Provisional application No. 63/521,231, filed on Jun. 15, 2023.

(51) Int. Cl. G06F 16/93; G06V 30/32; G06V 30/414; G06V 30/42

(52) U.S. Cl. CPC G06F 16/93; G06V 30/333; G06V 30/414; G06V 30/42

(57) ABSTRACT

Automated document ingestion (ADI) provides a comprehensive system and method to streamline document ingestion automation through developing, deploying, and monitoring machine learning models and tools. The system is designed to integrate alongside existing manual entry pipelines within a company. ADI has multiple components to accomplish each step of this task, namely document enhancements, an augmented data entry user interface, and a machine learning operations (ML Ops) pipeline.

### CROSS-REFERENCE TO RELATED APPLICATION

This application claims priority to U.S. Provisional Application Ser. No. 63/521,231, filed Jun. 15, 2023, the entire contents of which are hereby incorporated by reference in their entirety.

### FIELD OF THE INVENTION

The present invention discloses systems and methods for automating document ingestion.

### BACKGROUND

Document ingestion here refers to the process of importing documents into a system or application. This process can involve extracting data from documents, converting them to a machine-readable format, and storing them in a database or other storage medium. Document ingestion typically involves several steps, including data extraction, transformation, and loading. During the data extraction process, the system must identify the relevant data fields in each document and extract this information into a structured format. Once the data is extracted, it may need to be transformed into a standardized format that can be easily processed by the system. The transformed data is then loaded into the system's database, where it can be searched, analyzed, and processed. Historically, document ingestion has been a manual and time-consuming process. It involved reading through each document, identifying the relevant information, and entering it into a spreadsheet or data entry screen. Attempting to automatically perform this document ingestion can present challenges, particularly in dynamic environments where document formats may vary widely or change frequently. Therefore, a need exists for an ADI system capable of performing document ingestion more efficiently.

### SUMMARY

ADI is a comprehensive system designed to streamline document ingestion automation through developing, deploying, and monitoring machine learning models and tools. The system is designed to integrate alongside existing manual entry pipelines within a company. ADI has multiple components to accomplish each step of this task, namely document enhancements, an augmented data entry user interface, and a machine learning operations (ML Ops) pipeline.

### BRIEF DESCRIPTION OF THE DRAWINGS

FIG. 1 depicts a system diagram of the ADI and its components according to an embodiment of the invention.

FIG. 2 depicts how the ADI may be integrated into an existing document ingestion pipeline.

FIG. 3 depicts an embodiment of the process utilized by the Annotation machine according to an embodiment of the invention.

FIG. 4 depicts the process for matching abounding box with a key-value pair to create an annotation according to an embodiment of the invention.

FIG. 5 depicts an embodiment of the process utilized by the Simulator according to an embodiment of the invention.

FIG. 6 depicts an example document having bounding boxes.

FIG. 7 depicts a flowchart of the auto rotation process according to an embodiment of the invention.

FIG. 8 depicts an example document image with word vectors added.

FIG. 9 depicts a flowchart of the auto cropping process according to an embodiment of the invention.

FIG. 10 depicts components of the Augmented data entry UI according to an embodiment of the invention.

FIG. 11 depicts the ML ops pipeline according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

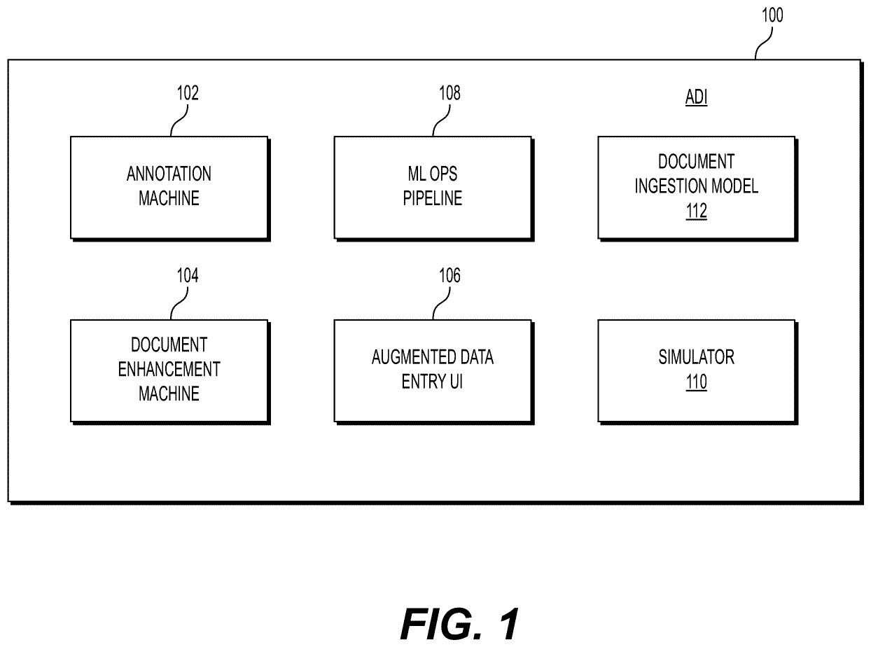

Referring first to FIG. 1, ADI 100 provides a comprehensive system designed to streamline document ingestion automation through developing, deploying, and monitoring machine learning models and tools. ADI 100 is designed to integrate alongside existing manual entry pipelines within a company. ADI 100 comprises multiple components to accomplish each step of this task:

Annotation machine 102—Utilizes historical data from data entry and corresponding document images to generate labeled data for training object detection models. Annotation machine 102 allows for large quantities of high-quality labeled training data with minimal manual effort.

Document enhancement machine 104—Preprocessing steps are applied to documents, both to improve model performance and to improve the experience for human readers. These steps may include, but are not limited to, auto-rotation, deskewing, cropping, and contrast enhancement.

Augmented data entry user interface (UI) 106—UI 106 can be deployed in place of existing data entry tools to improve ongoing data entry efficiency while generating additional training data and closing the loop for ongoing model validation and monitoring.

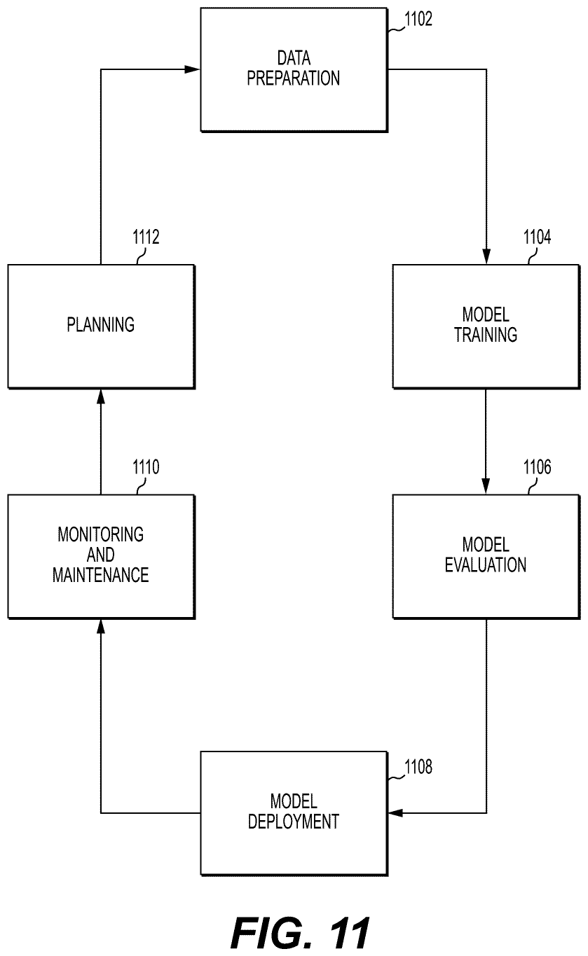

Machine learning operations (ML Ops) pipeline 108—This pipeline allows for training and deploying models, and leveraging data generated by the Annotation machine 102. It incorporates steps for validating, deploying, monitoring, and consistently refining models to ensure high performance and adaptability to new challenges (FIG. 11).

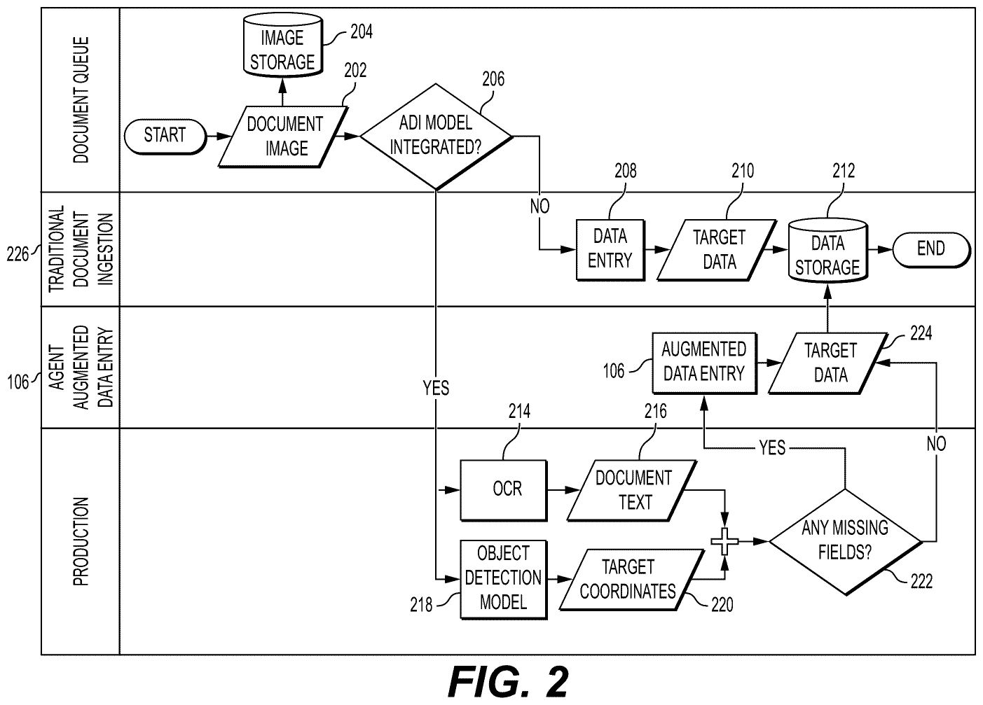

An overall view of ADI 100 and how it integrates into an existing document ingestion pipeline can be seen in FIG. 2. As depicted, in an existing document ingestion pipeline, a document image is loaded from image storage database 204 in step 202. Image storage database 204 contains all images of scanned/imaged documents such as invoices, bills of sales, etc. that require processing (e.g., data entry). ADI 100 determines in step 206 if the loaded document image is of a type that can be processed by ADI 100. If the document image is not ADI integrated, traditional document ingestion 226 occurs. A worker viewing the image performs data entry of the various fields from the document image in step 208. The entered information is then stored in field database 212 in step 210 and the process ends since the required data has been analyzed by the worked and stored.

However, if ADI 100 determines that the document image is of a type that is ADI model integrated in step 206, OCR is performed on the document image in step 214 and field data is extracted and identified in step 216. Simultaneously, various objects are detected by ADI 100 in step 218 and bounding boxes are placed around the detected objects (e.g., addresses, quantities, product descriptions, etc.). The target coordinates of each object (e.g., corners of the bounding box) are determined in step 220. The document text within each object is analyzed to determine if any fields are missing from the document image in step 222. For example, the document image may be missing some fields or OCR may not be able to recognize certain text if the document is damaged.

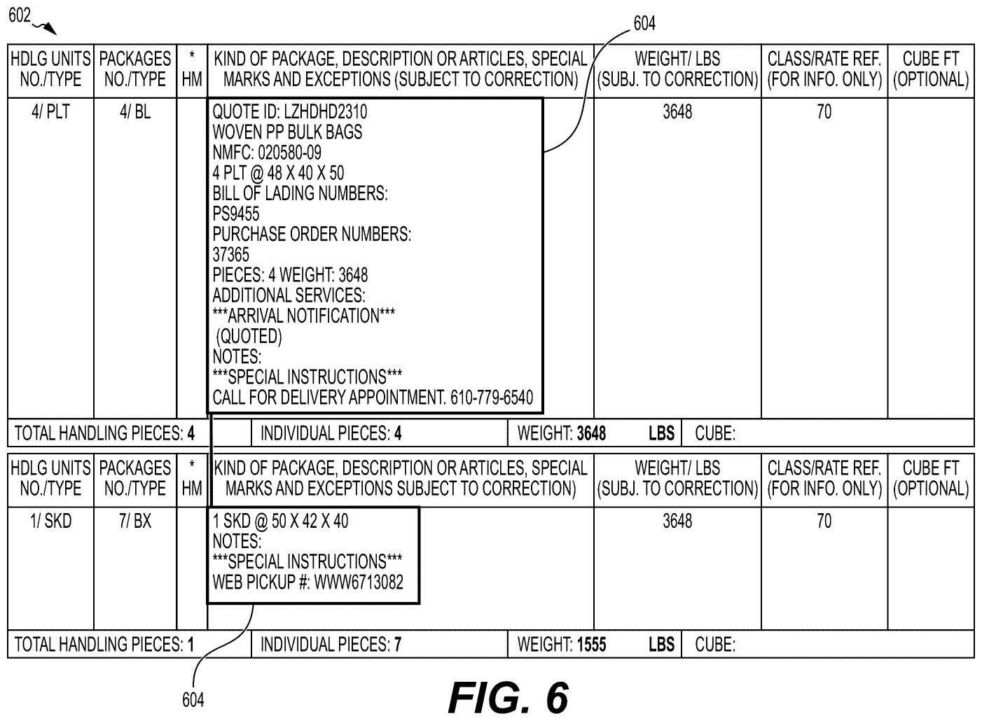

For any detected object, the corresponding text is then displayed within the bounding box as depicted in FIG. 6 (e.g., bounding box 604) and the bounding box is highlighted (e.g., in a certain color or with a certain line thickness) utilizing Augmented data entry UI 106 which will be described in more detail later. For each bounding box with text, a worker only has to verify the target data in the bounding box in step 224 and it is then stored in field database 212. This allows a worked to quickly review many displayed fields and only requires the worker to verify the information displayed within the bounding box instead of requiring the worked to manually enter the data as in step 208. As more document images and document types are processed, Augmented data entry UI 106 is able to populate the text in more fields over time because of the ADI learning from the traditional document ingestion pipeline 226 as will be described later.

ADI 100 may be implemented on any computing architecture and is scalable. For example, for a small-scale company, ADI 100 may be implemented on a computer or local server having a processor if a great deal of computing power is not required. However, if more proccing power is required, ADI 100 may be implemented on a server farm, a cloud computing system (e.g., infrastructure as a service IaaS, platform as a service (PaaS), software as a service (SaaS) like Microsoft Azure® or Amazon Web Services®, etc.

### ADI 100 Case Study

The following description provides a case study as to how ADI 100 can improve the workflow of document ingestion for a company. A company may require a significant number of employees (e.g., 200 or more) to handle the task of ingesting Bills of Lading (BOL) daily. The BOLs received by the company may range between 20,000 and 30,000 per day, making it a challenging task to manage. One of the difficulties that such a company faces when processing BOLs is that there are thousands of different formats for these documents, making it tough to develop a BOL model that can handle such diversity. Additionally, BOLs are information-dense, often with over 60 fields that must be extracted for each document.

To create a model that can handle these challenges, a vast number of training examples are required. However, it was discovered by the inventors after an initial analysis that building a single model capable of handling the diversity of BOL fields and formats would necessitate hundreds of thousands of examples for training. Unfortunately, manually creating a high-quality annotation for a single BOL document takes an average of 15 minutes. This would require 125,000 hours or 15,000 workdays to create 500,000 annotated documents, which is entirely unfeasible to do manually. As a result, it would be necessary to reduce the training dataset size.

The Annotation machine 102, by comparison, has the capability of generating the necessary data in only 15 hours, making it possible to create a trained model that can manage the large variety of BOL formats and fields. The trained model achieves state of the art level results for this application and has since been deployed and has successfully automated the ingestion of a significant portion of incoming BOLs for the company.

### Annotation Machine 102

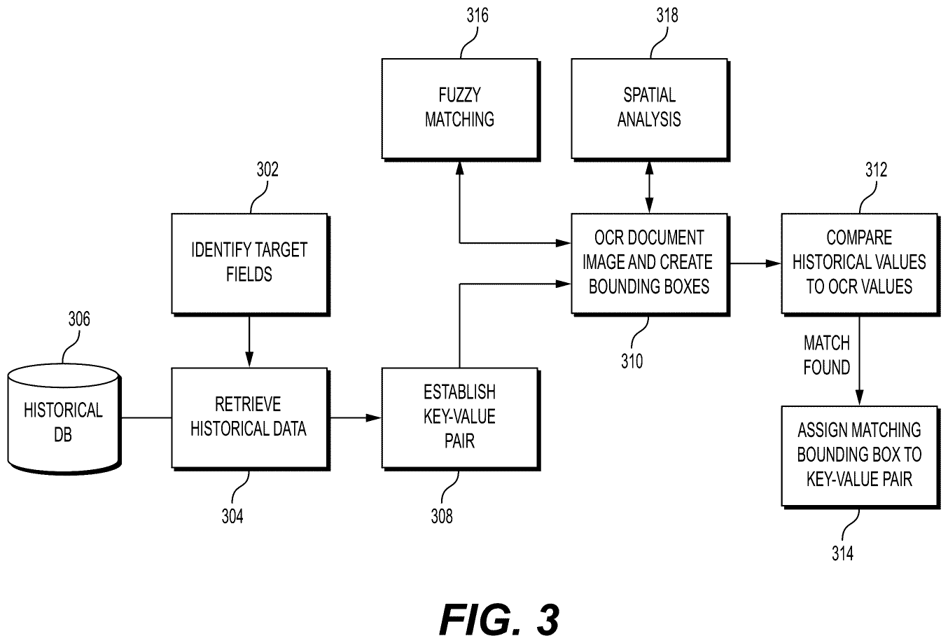

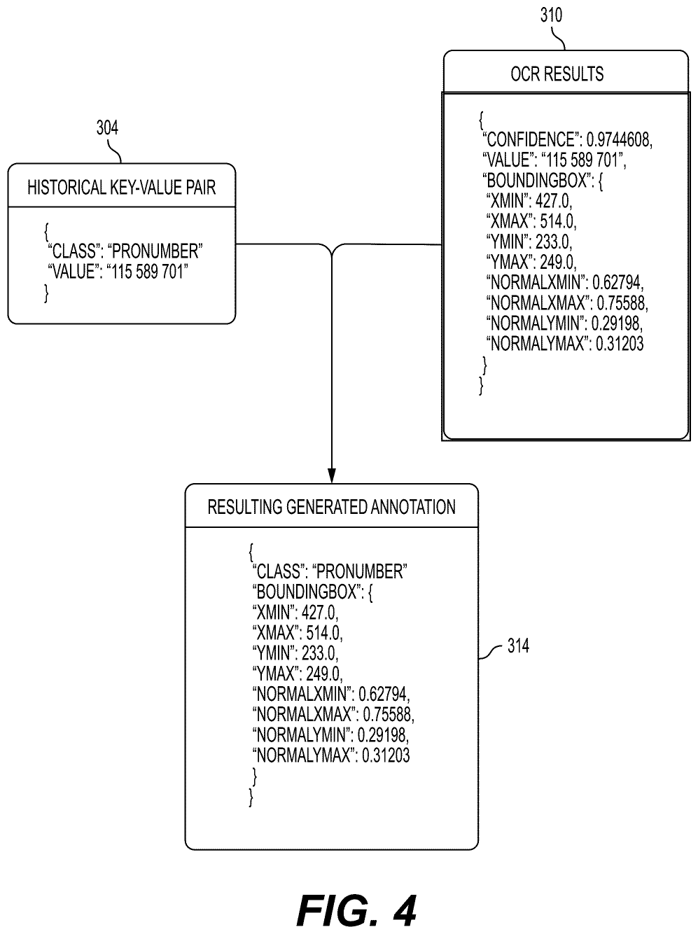

The Annotation machine 102 is an automated solution that leverages pre-existing manual data entry processes to generate accurate models to automate the pipeline. Unlike other automated solutions, the Annotation machine 102 benefits from the historical data entry process involved in manual ingestion. By doing so, it can generate labeled data that is reliable and can be used for training object detection models. To generate labeled data, the Annotation machine 102 first identifies the target fields that were manually scraped by data entry personnel and that the business wishes to automate in step 302 as depicted in FIG. 3. For a given document, the target historical data is retrieved from historical database 306 in step 304, and a key-value pair is established in step 308. The document image is then processed through Optical Character Recognition (OCR) in step 310, and the historical value is compared to all values found by OCR in step 312. When a match is found, the bounding box determined by OCR (e.g., bounding boxes 604 in FIG. 6) is assigned to the key-value pair in step 314 to create the annotation. A straightforward example of this can be seen in FIG. 4. Steps 302-214 are repeated for all target fields on the document image. The result is an image annotation containing class and bounding boxes that can be used to train an object detection model. Using the method depicted in FIG. 3, the Annotation machine 102 can generate a fully annotated image with ˜100 fields in less than a second, which is significantly faster than a human. Additionally, the process can be easily parallelized, further decreasing processing time. As a result, the Annotation machine 102 can generate quantities of data orders of magnitude higher than would ordinarily be reasonable to obtain.

### Fuzzy Matching 316

Oftentimes, the historical data that has been scraped and stored in historical database 306 may not precisely correspond to the text extracted by OCR in step 310 due to potential data entry errors, transliteration issues, or inaccurate OCR. To address these instances, ADI 100 may employ fuzzy matching techniques 316 in step 312 to identify the closest match within a given document. Text fuzzy matching is a technique used to compare two strings of text and determine how similar they are (e.g., by generating a confidence score as depicted in OCR Results 310 FIG. 4), even if they are not an exact match. By using fuzzy matching techniques, Annotation machine 102 can still identify matching records or entities even if they are not an exact match.

### Spatial Analysis 318

When analyzing documents that contain information in tables, graphs, or other structured formats, the spatial context of the data becomes even more crucial. Tables and graphs are designed to display information in a specific layout, often grouping relevant data together in a clear and structured manner. By taking advantage of this spatial context, it is possible to extract even more comprehensive and interconnected information from these documents. One common example of this is invoices which often contain a large amount of structured data as depicted in document 602 in FIG. 6. By analyzing the layout of the document 602 using spatial analysis in step 318, it becomes possible to identify the different sections of the invoice and link related fields together in step 312.

### Simulator 110

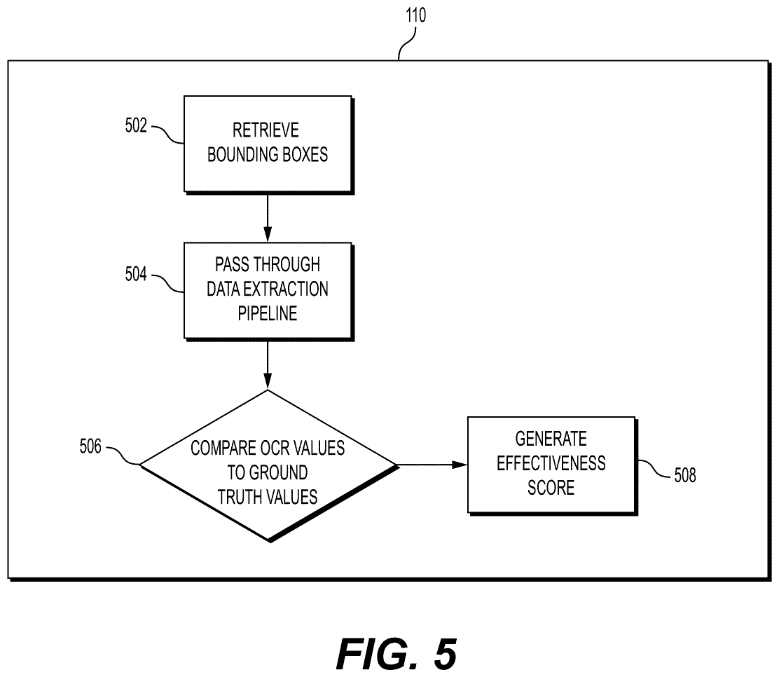

Once the Annotation machine 102 has been used to generate labeled data, it is crucial to validate the accuracy of the labels. ADI 100 does this through utilizing Simulator 110 as depicted in FIG. 5. In this system, the bounding boxes created by the annotation machine in step 310 are retrieved in step 502 and passed through the rest of the data extraction pipeline (FIG. 2) as if they came from an object detection model in step 504. An example document 602 (e.g., a shipping manifest) is depicted in FIG. 6 with bounding boxes 604.

For a given document, OCR values within the provided bounding boxes 604 are then extracted and compared to the ground truth values in step 506 to produce a score that represents the effectiveness of the Annotation machine 102 in step 508. If the score is low, indicating a significant difference between the prediction and the ground truth, it suggests that there are issues with how the annotations are being automatically generated by Annotation machine 102. Recognizing these issues early allows for adjustments to be made to the Annotation machine 102 before the object detection model is trained, thus saving computing time, and improving the final model. Adjustments may range from custom code for handling unique scenarios, to reviewing the historical ground truth data to validate that it matches the data as it exists on the original document. The Annotation machine 102 and the Simulator 110 work together to generate large quantities of labeled training data with minimal human labor, while still being able to validate the quality of the data before committing to the expense of large model training.

Enhancing Model Precision with Historical Data Insights

ADI 100 leverages historical data at inference time to improve the accuracy and effectiveness of its Document ingestion model 112. By analyzing and incorporating supplementary context and information derived from historical data (e.g., from historical database 306), ADI 100 can refine the model's 112 output, making it more reliable and accurate. For example, if ADI 100 is used to extract invoice data from a particular vendor, historical data about that vendor can be used to refine the model's 112 output. The historical data may include information about the vendor's billing practices, such as the types of items they typically bill for, the format of their invoices, and any common errors or inconsistencies in their billing data. By incorporating this additional context into the Document ingestion model 112, ADI 100 can better identify and extract the relevant data from the vendor's invoices.

In addition, ADI 100 can use historical data from historical database 306 to fill in missing values or supply additional context to the extracted data, further enhancing its reliability and accuracy. For example, if an invoice amount is extracted but does not have information about the currency used, historical data about the vendor's billing practices can be used to infer the correct currency.

Finally, results collected from model evaluation (e.g., by Simulator 110) is used to validate the data extracted by the Document ingestion model 112. When fields are related, ADI 100 uses the field with higher confidence to validate the values retrieved for fields with lower confidence. For example, if the Document ingestion model 112 is highly confident (e.g., a high score) in its ability to retrieve the shipper zip code, it can be used to confirm the accuracy of the shipper address and city on a document 602.

### Document Preprocessing

As document images 602 are received into the document ingestion pipeline of FIG. 2, multiple preprocessing steps are applied to images to maximize the accuracy of OCR and the object detection models by Document enhancement machine 104. These processes encompass a range of techniques such as noise reduction, contrast enhancement, automatic rotation correction, and auto cropping, among others. Noise reduction is typically achieved through the application of Gaussian blur, while contrast enhancement is performed by Histogram Equalization or Binarization, all of which are classical computer vision methods. Auto rotation and Auto cropping, on the other hand, are performed within ADI 100 by leveraging information from OCR to ensure the operations are robust and unlikely to negatively impact the information present in the document.

### Auto Rotation Process 702

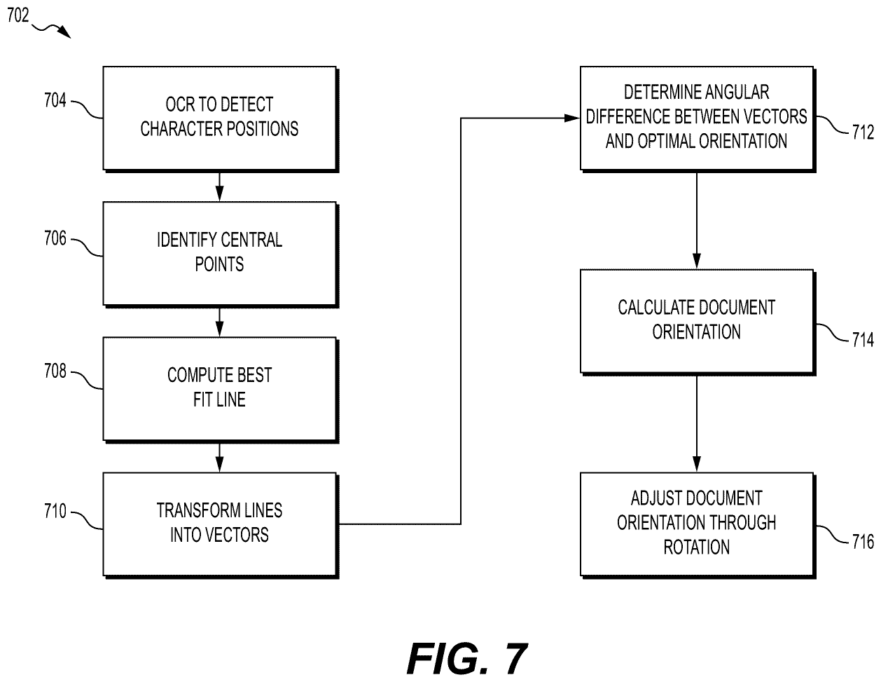

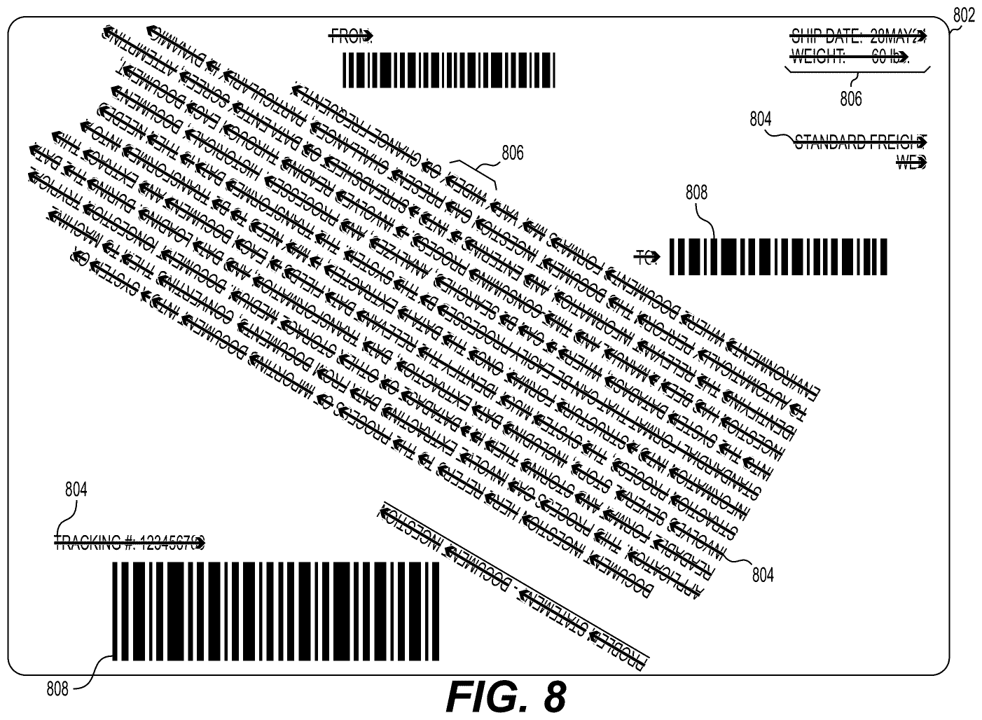

As the primary application of ADI 100 is to text documents (see e.g., FIG. 6 and FIG. 8), the text content of the document image 802 can be leveraged to automatically detect and correct the orientation of the document image 802 using auto rotation process 702 as depicted in FIG. 7 which is described with reference to document image 802 in FIG. 8.

First, the Document enhancement machine 104 conducts OCR on the document 802 in step 704. Initially, the focus is not on extracting accurate text but on identifying the positions of all characters 804. Because of this, a lower resolution of the document 802 can be passed through OCR to minimize inference time. The central point of each character is identified in step 706 for every word present on the document 802. A line of best fit through the center points of the characters 804 is computed in step 708. Each line is transformed into a vector 806, extending from the first character 804 to the last character 804 in each word in step 710. For each vector 806, an angular difference between the vector 806 of each word and an optimal orientation (e.g., horizontally to the right) is determined in step 712. The document's 802 orientation angle is calculated by identifying the most frequently occurring angle across all word vectors 806 in step 714. The determined orientation angle is then used to adjust the orientation of document 802 in step 716 by rotating it in the direction opposite to the identified orientation angle.

Although this method has some drawbacks, such as requiring a dedicated call to OCR, the use of text content within the page results in a very robust solution. By comparison, a classical computer vision method such as detecting Hough Lines often provides poor results in documents that have non text content, such as logos, images, or graphs 808.

Once the orientation of the document 802 is corrected in step 716, it can be fed into other preprocessing steps, or the full resolution image can be passed in OCR and Object Detection. Although some OCR and object detection models have been trained with poorly oriented documents in mind, testing has shown that correcting orientation before inference improves overall results.

### Auto Cropping 902

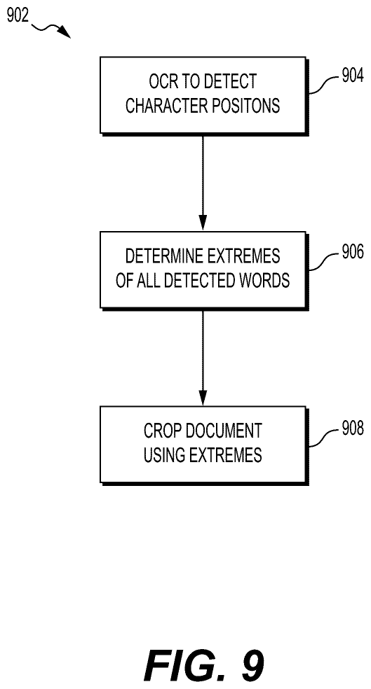

An automatic cropping process 902 can be carried out by Document enhancement machine 104, similar to auto rotation process 702. As depicted in FIG. 9, a lower resolution of the document image is passed to OCR in step 904. If the document 802 has been auto rotated already in step 716, the OCR results used for that purpose can be reused here. The bounds of document 802 are determined in step 906 by taking the extremes of the minimum and maximum positions of all detected words. The document 802 is then cropped in step 908 to the extremes determined in step 906. A configurable padding value can be added to this cropping (e.g., to the edges of document 802).

Auto cropping process 902 is particularly useful for removing scanning artifacts around the borders of pages. When combined with auto rotation process 702, this method proves to be very reliable at cropping cleanly to just the text content of the page.

### Augmented Data Entry UI 106

As previously discussed, ADI 100 includes Augmented data entry UI 106 designed to improve the workflow of data entry processes. It can be rapidly customized to fit customer's specific requirements, allowing users to transition from existing tools with minimal impact to workflow. Data collected with OCR can be used to improve user experience and efficiency, while also generating labeled data for model training without any additional effort.

### Integration—Dynamic Layouts

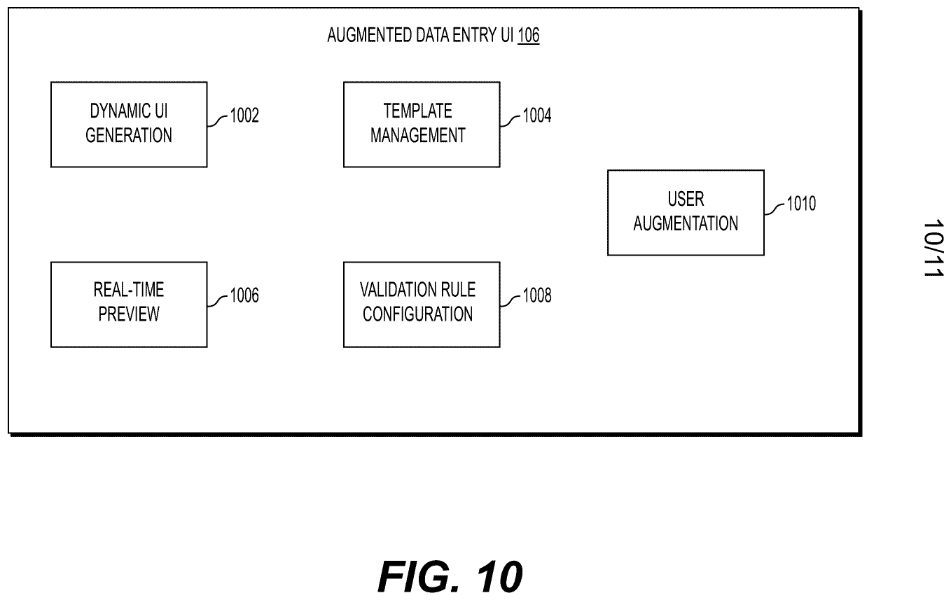

In most data entry pipelines, custom tooling is usually in place, specifically designed for the particular data being extracted. For any replacement tools to be considered effective, they need to match the functionality of the original tools. With that in mind, a core functionality of the Augmented data entry UI 106 is to be able to dynamically alter its data entry elements to match the data or use case. The key components of this functionality are depicted in FIG. 10:

Dynamic UI Generation 1002—Users can dynamically create and modify data entry forms. The system allows for the insertion of various form elements and specifies attributes like name, type (e.g., text, number, date), validation rules (e.g., required, max/min length), and placeholder text.

Template Management 1004—Provides functionality to save, retrieve, and manage predefined templates for data entry UIs. Users can start with a template and customize it to fit their specific needs.

Real-time Preview 1006—As users design their forms, a real-time preview feature 1006 displays how the forms will appear to the end-users, enabling on-the-spot adjustments to the layout.

Validation Rule Configuration 1008—Enables the setting of validation rules for each form element to ensure data quality. This includes required fields, data type checks, range constraints, and custom validation scripts.

These aforementioned capabilities allow for the Augmented data entry UI 106 to be integrated into existing data entry workflows without the need of developing custom tools from scratch.

### User Augmentation 1010

Traditionally, data entry requires manual typing of information. This process can be time-consuming and prone to errors, leading to the need for the user to put in significant effort to ensure accuracy. The Augmented data entry UI 106 addresses these issues by utilizing an agent assistance tool 1010 with OCR technology, which automates the extraction of text from documents. Instead of manual data entry, the document is presented to the user, who can simply click on the relevant information to populate corresponding data fields. This significantly reduces the amount of manual effort required and minimizes the risk of errors, allowing the user to focus on verifying accuracy and making any necessary corrections.

Finally, as the user selects values and assigns them to the appropriate fields, the information is being combined with the corresponding bounding boxes 604 from OCR to generate labeled data. Essentially, the data entry screen becomes a ground truth generator without requiring any extra effort.

The augmented data entry UI 106 enables a closed loop for deployed ML models by facilitating validation, monitoring, and ground truth generation. First, in situations where the ML model only partially extracts the required fields from a document, the document is automatically forwarded to a manual review queue. Fields that were successfully identified can be pre-filled. Fields identified with low confidence are flagged for verification. This process significantly enhances efficiency, as manual reviewers focus solely on verifying uncertain fields or filling in missing ones, rather than processing the entire document from scratch. This combined with the OCR augmentation previously discussed means ground truth data will be passively generated for low confidence fields.

Next, ADI 100 can be configured to select a statistical sample of documents for manual review. These documents are both processed by the ML model and sent to the manual data entry queue. Results from each are compared to detect any issues, such as model drift, poorly performing fields, or other anomalies that could impact the accuracy of the data integration process.

These approaches result in a closed loop ML system, as model weaknesses are addressed through targeted manual processing into ground truth data, which can be used to further fine-tune the model.

### Machine Learning Operations Pipeline 108

ADI 100 is designed to operate as a full ML Ops pipeline 108, from data collection to model deployment and monitoring as depicted in FIG. 11. First, data is collected and prepared in step 1102 through an evaluation of the existing processes and data. In scenarios where historical data is available, the Annotation machine 102 can be leveraged to generate labeled training data. Understanding historical data can lead to context that is applicable to techniques for post-processing and validating data after model inference.

The development process of the Document ingestion model 112 involves training Document ingestion model 112 in step 1104 on data produced by the Annotation machine 102. The accuracy of Document ingestion model 112 is evaluated in step 1106 through testing against authentic data within a controlled test environment. High-performing models advance to production and deployment in step 1108. Here, new documents are automatically directed to the model, bypassing manual processing queues.

The components of the Document ingestion model 112 are continuously monitored for accuracy and maintenance in step 1110. Continuous monitoring of deployed models is critical to maintain their efficiency and performance.

The Augmented data entry UI 106 offers a means to both validate model accuracy and create ground truth data for fields where the model underperforms.

Identification of underperforming models or specific fields allows for targeted fine-tuning and redeployment in step 1112. The cycle depicted in FIG. 11 ensures the Document ingestion model 112 not only improves over time, but also mitigates the risk of model deviation.

### Advantages of ADI 100

As discussed, ADI 100 provides a comprehensive, end to end, system for automatically capturing data from documents (e.g., 602, 802). ADI 100 integrates into customer's existing document pipelines to mitigate the need for manual data scraping and data entry. Further, ADI 100 leverages ML technologies to extract information from documents.

ADI 100 utilizes computer vision techniques to preprocess document images to improve data extraction results via Document enhancement machine 104. Auto rotation process automatically correct page orientation and skew while auto cropping process 902 automatically resize pages to optimize text size for OCR.

Annotation machine 102 provides a novel system within ADI 100 which enables the creation of massive amounts of labeled data for model training which would typically be prohibitively expensive. Historical data from existing data ingestion pipelines is leveraged to generate labeled object detection training data. The quantities of data generated by the Annotation machine 102 are multiple orders of magnitude higher than what would be feasible by manual data labeling. This approach leverages the expertise of the staff to produce a significantly improved dataset, and consequently, a superior model, compared to what might be achieved through labeling by someone external.

Augmented data entry UI 106 provides a tool that can replace existing data entry tools to serve multiple purposes. Template management 1004 allows custom UI templates to be generated to match the UI to the exact data that is being extracted. This allows the UI to be easily integrated into customer's workflow regardless of data formats, validation, or other requirements. User augmentation 1010 performed on document images allows users to click on target data that has been pre-filled to verify it rather than needing to manually type, resulting in faster data entry. That is, user augmentation 1010 can pre-fill different fields and highlight those fields, only requiring users to quickly review the already entered information instead of needing to manually enter it.

Further, if ADI 100 doesn't successfully capture all necessary information, the document can be shown to the user with the fields that were correctly identified already filled in. This way, the user only needs to fill in the missing details. This process can generate data that helps fine-tune Document ingestion model 112, leading to better performance in capturing those fields in the future. As users perform data entry, labeled training data is generated from the OCR values and bounding boxes 604. This data can be used for further training or model fine tuning.

Continuous model monitoring through Machine learning operations pipeline can be performed by feeding a statistical sample of documents through the UI for manual data capture. This user generated ground truth can be compared against the model output to validate model accuracy and detect any model drift over time.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method for performing automated data ingestion (ADI), the method comprising:
receiving a document image from a plurality of document images;
determining a document type of the document image from a plurality of document types;
if the document type is an integrated document type, performing image preprocessing on the document image;
performing optical character recognition (OCR) on the document image to determine a plurality of text and a corresponding plurality of document coordinates of the document text in the document image;
concurrent with the OCR, detecting a plurality of field types and a corresponding plurality of field type coordinates in the document image;
matching the plurality of text and the plurality of field types utilizing the plurality of document coordinates and the plurality of field type coordinates;
determining any missing field types from the plurality of field types not detected in the document image;
automatically annotating the document image with a plurality of bounding boxes using an augmented data entry user interface (UI) and displaying a field type name for each of the bounding boxes from the plurality of field types;
receiving approval or rejection of each of the plurality of bounding boxes by a user of the ADI; and
for each of the plurality of bounding boxes receiving approval, storing corresponding text within the bounding box with the field type name in a field database in association with the document image.

2. The method according to claim 1, wherein the image preprocessing comprises:
performing automatic rotation on the document image; and
performing automatic cropping on the document image.

3. The method according to claim 1, wherein the matching utilizes fuzzy matching or special analysis to perform the matching.

4. The method according to claim 1, wherein the matching compares historical stored values to each of the plurality of text to determine the field type name displayed in association with each bounding box.

5. The method according to claim 4, wherein the comparison of the historical stored values to each of the plurality of text is assigned a matching score, and
wherein a match is confirmed for each of the plurality of text if the matching score is above a predetermined threshold.

6. The method according to claim 1, wherein the image preprocessing comprises:
performing OCR on the document image to identify a plurality of characters comprising a character type and a character position for each character in the document image;
detecting a plurality of text from the plurality of characters,
wherein each of the plurality of text comprises at least one character from the plurality of characters;
for each of the plurality of characters, identifying a center coordinate of the character using the character position;
for each of the plurality of text, computing a best fit line through center coordinates of any character positions associated with the text to produce a plurality of best fit lines;
transforming each of the plurality of best fit lines into a plurality of text vectors,
wherein each text vector of the plurality of text vectors has a direction extending from a first character to a last character of the characters associated with the corresponding text;
for each of the plurality of text vectors, calculating an angular difference between the text vector and an optimal orientation vector;
determining a most frequent angular difference occurring across the plurality of text vectors; and
automatically rotating the document image in a direction opposite to the most frequent angular difference to produce a rotated document image.

7. The method according to claim 1, wherein the image preprocessing comprises:
performing OCR on the document image to detect a plurality of text;
for each of the plurality of text, determining a minimum position and a maximum position;
determining an extreme minimum position and an extreme maximum position from the determined minimum positions and the determined maximum positions; and
automatically cropping the document image by cropping values determined using the extreme minimum position and the extreme maximum position as cropping locations.

8. The method according to claim 7, further comprising:
adding a predetermined horizontal buffer and a predetermined vertical buffer to the cropping values prior to automatically cropping the document image.

9. A method for performing automated data ingestion (ADI), the method comprising:
receiving a document image from a plurality of document images;
determining a document type of the document image from a plurality of document types;
if the document type is an integrated document type, performing image preprocessing on the document image;
performing OCR on the document image to identify a plurality of characters comprising a character type and a character position for each character in the document image;
detecting a plurality of text from the plurality of characters,
wherein each of the plurality of text comprises at least one character from the plurality of characters;
for each of the plurality of characters, identifying a center coordinate of the character using the character position;
for each of the plurality of text, computing a best fit line through center coordinates of any character positions associated with the text to produce a plurality of best fit lines;
transforming each of the plurality of best fit lines into a plurality of text vectors,
wherein each text vector of the plurality of text vectors has a direction extending from a first character to a last character of the characters associated with the corresponding text;
for each of the plurality of text vectors, calculating an angular difference between the text vector and an optimal orientation vector;
determining a most frequent angular difference occurring across the plurality of text vectors; and
automatically rotating the document image in a direction opposite to the most frequent angular difference to produce a rotated document image.

10. The method according to claim 9, further comprising:
for each of the plurality of text, determining a minimum position and a maximum position;
determining an extreme minimum position and an extreme maximum position from the determined minimum positions and the determined maximum positions; and
automatically cropping the document image by cropping values determined using the extreme minimum position and the extreme maximum position as cropping locations.

11. The method according to claim 10, further comprising:
adding a predetermined horizontal buffer and a predetermined vertical buffer to the cropping values prior to automatically cropping the document image.
